(19) United States
(12) Patent Application Publication
(10) Pub. No.: US 2010/0212598 A1
(43) Pub. Date: Aug. 26, 2010

(54) COMPOUND APPARATUS HAVING REDUNDANT FLOAT ACTUATED DEVICES AND SOLENOID TO CONTROL WATER LEVEL AND CHEMISTRY IN AN AQUARIUM OR SUMP

(76) Inventor: JAMES PHILLIP JONES, Jefferson City, MO (US)

Correspondence Address: JAMES PHILLIP JONES, 2809 SUE DRIVE, JEFFERSON CITY, MO, 65109-0558, US

(21) Appl. No.: 11/850,734

(22) Filed: Sep. 6, 2007

(51) Int. Cl. A01K 63/04; F16K 31/18

(52) U.S. Cl. 119/269; 137/412

(57) ABSTRACT

A universally fitting apparatus to hang onto an aquarium or sump and automatically regulate replacement of evaporated water in real time. Further, while maintaining the fluid level and salinity of the total body of water, a normally closed solenoid, actuated by a float switch, will act redundantly with a float valve to meter incoming fluid. Said solenoid will act to close the water source in the event that the float valve fails to operate or in the event of power failure to shut off the incoming water. For additional safety, the power supply may be plugged into an electronic programmable timer to further minimize the likelihood of an overflow.

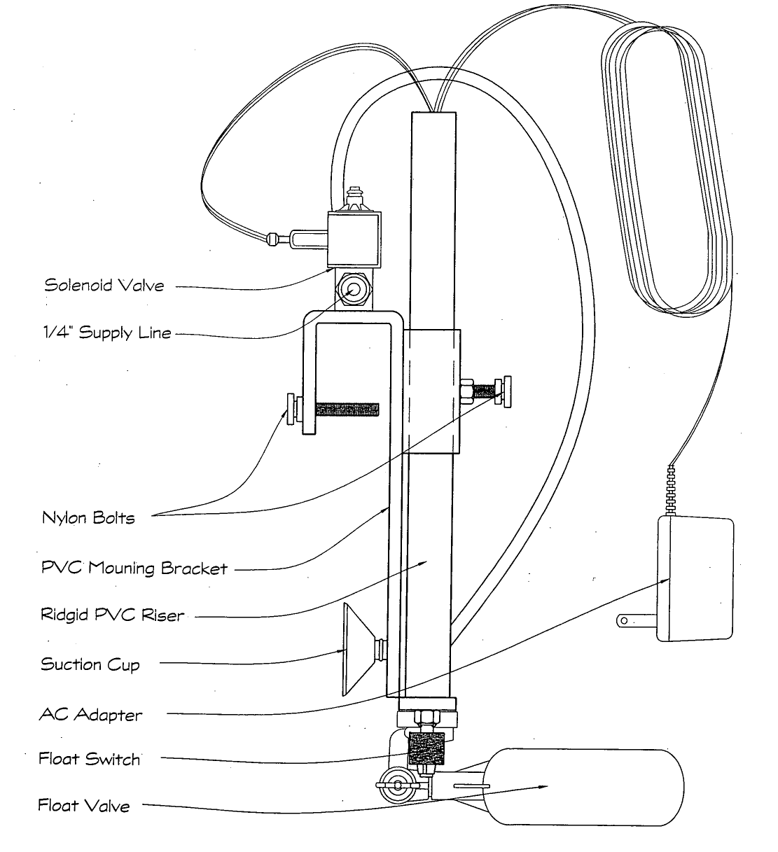

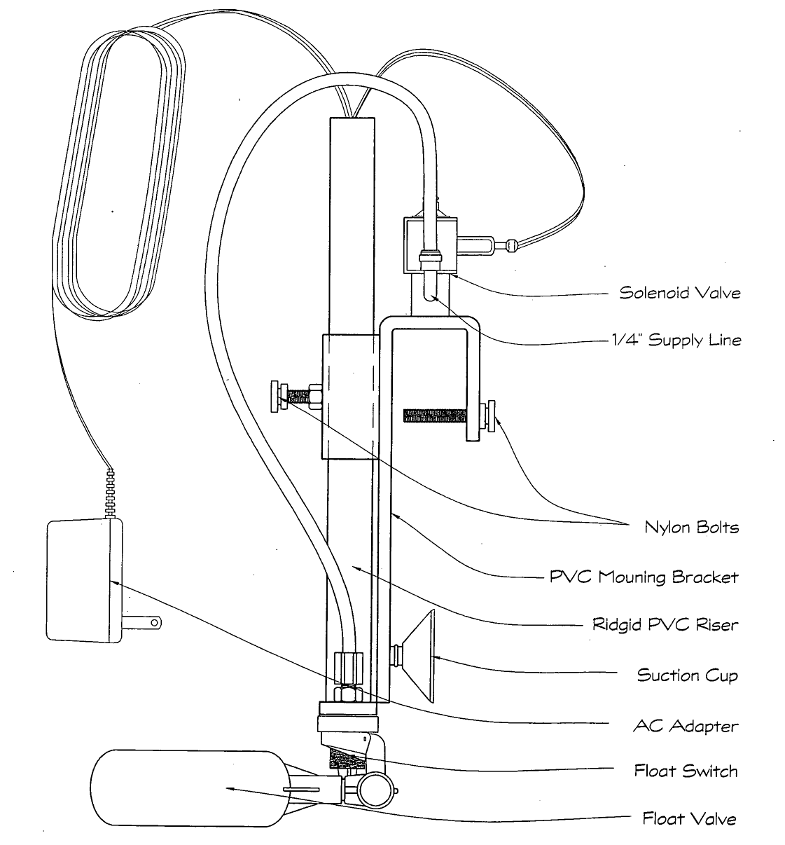

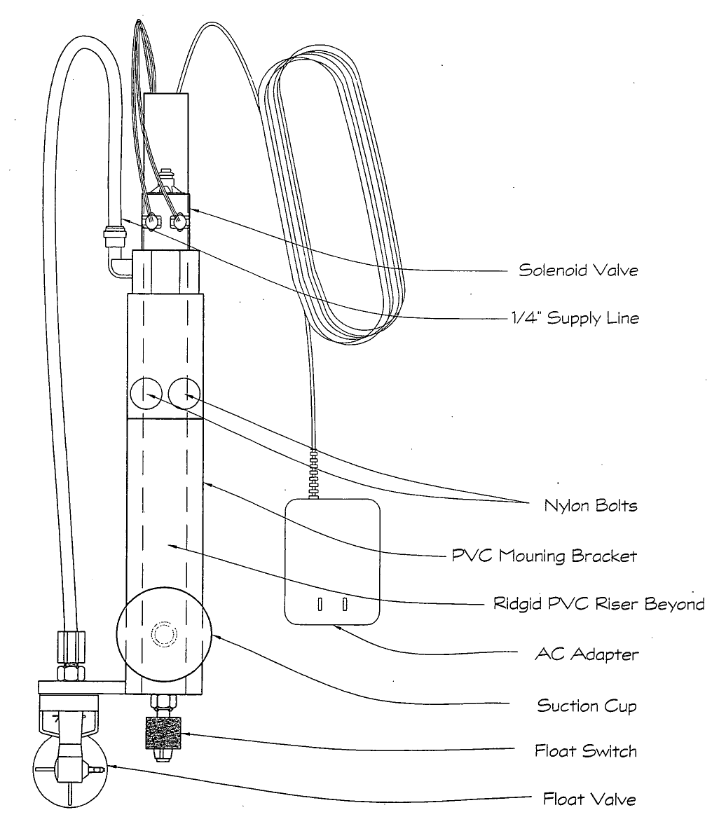

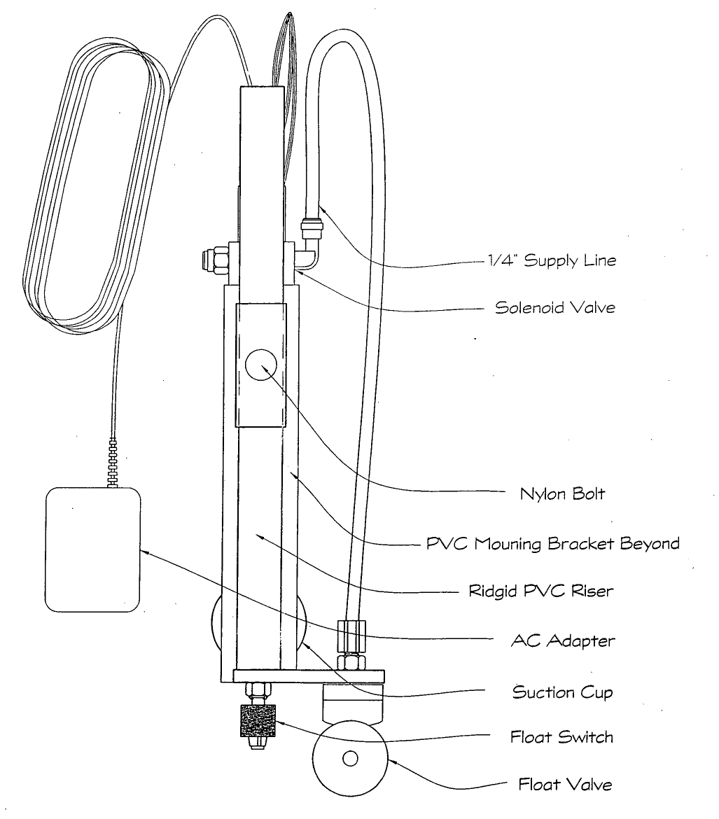

### FIELD OF THE INVENTION

The present invention relates to the freshwater and saltwater aquarium hobbies, institutions and industry. More precisely to the handling of the fluids contained within the bodies of water, in which captive life forms are kept, propagated and maintained.

### BACKGROUND OF THE INVENTION

In the aquarium environment, the evaporation of water caused by high yield lighting components, surface area, and increased flow rates has long been an obstacle for the keeper of captive aquatic species. Attempts at compensating for this loss have ranged from pouring water directly into the tank periodically, to placing closed glass tops over the tank to prevent evaporation. Both methods are inferior. Pouring water directly into the tank on daily intervals allows water parameters to change substantially before being returned to its original state; further, the addition of bulk water produces a sudden change in water parameters that is different than the water conditions that occur in nature. This method also requires manual intervention on a daily basis. By placing tight glass lids over an aquarium, the condensation, which naturally occurs, inhibits the adequate penetration of light into the water at a natural depth. Further, as said condensation dries, water spots and residue are left on the glass, further impeding the natural light penetration and downward visibility into the aquarium. Glass tops further obstruct access into the tank with additional husbandry equipment such as air tubing, heater cords, power head hangers, etc., required to create conditions favorable to the inhabitants of the desired species chosen by the keeper. Closed glass tops also trap heat and prohibit the rise of heat from the water surface; thereby, causing a buildup of unnatural temperatures within the aquarium.

Previous rudimentary devices have additionally been used to compensate for evaporated water loss. Containers which gravity feed replacement water via a tube and valve have proven to be very inaccurate and unreliable. It seems a daunting task to release the water in a direct 1:1 ratio and keep the water level and chemistry constant. Stand alone float valves have been used with some success; however, these devices are subject to the interference of snails, buildups of calcium, various algae species, etc. Further, should a stand alone float valve stick in an open position, the system could easily be overflowed and/or significantly alter the water chemistry required to maintain any given species. This condition is substantially more critical in the saltwater habitat due to the fact that as pure water evaporates, the salt remains; thereby, having the net affect of increasing salinity, resulting in a condition known as hyper-salinity (increased). Conversely, was a float valve to stick in the open position, the salt would be drastically diluted resulting in hypo-salinity (decreased). Marine livestock is very sensitive to swings in salinity (expressed in parts per thousand [ppt]) and specific gravity, wherein the natural value of natural seawater (NSW) would be 1.0265.

Many very delicate freshwater species also require very demanding water parameters to survive and/or thrive, most notably the South American Amazon cichlid commonly known as the Discus. Discus require a sustained pH of 6.6 or lower. The evaporation of pure water in the Discus would result in the excessive presence of accumulated waste products and an imbalance in pH. Were a common float valve stick in the open position, the sudden addition of pure water (assuming a higher pH than the water in the tank) would cause a sudden rise in pH. Further, the stuck valve would also create a temperature swing taking the temperature below 82 degrees Fahrenheit; thereby, creating conditions that would likely cause bacterial or parasitic conditions in the tank. The concept of replacing water loss in real time is advantageous for all species maintained in an aquatic biosphere.

There have been attempts to further automate the real time replacement of water evaporation and/or loss. These attempts were comprised of a high and low limit float switch, controlling a relay that controls the off and on condition of small magnetic drive pumps. The pump is placed in a separate tank or container of water and the pump is kicked off and on in very quick and short bursts, as the float switches cause a circuit to close in the relay. The small amount of water is pumped, returning the float to on/off position very quickly. The faults in these systems are twofold: First, the capacity of the available water to replace the missing water is limited to the capacity of the tank/container. This additional tank/container also takes up valuable space in tight areas or small fish rooms. Secondly, the small magnetic drive pumps in these systems are designed to operate in continuous service and not in erratic short spurts. When these pumps fail to start when a relay circuit is made, the missing water is not replaced. Most commonly, the keeper has a false sense of security in the automated system resulting in excessive missing water to go unreplaced in a tank or aquarium; thereby, causing the massive loss of valuable livestock. These systems are designed to work on both 12-volt batteries and standard 110-volt ac current. 12-volt pumps are less powerful and the dependability of batteries is just another opportunity for the system to fail. While no prior art was found depicting this system, one can be viewed in the general domain at numerous aquarium related bulletin board sites on the Internet.

Methods described herein to replace evaporation and missing water in a tank or container consist of separate components comprising the present invention and are wired and/or plumbed together as a composite apparatus with plural components. This device combines all the necessary equipment in one unit that is easily mounted in the sump or aquarium. Furthermore, float valves on the market today are built with a bulkhead which is designed to be mounted through a hole drilled in the side of the sump or aquarium. This is difficult and/or costly to do for most keepers. Drilling glass requires special diamond encrusted drill bits and a high level of skill and experience. Some aquariums are built from tempered glass and cannot be drilled. This unit fastens to the side of the tank and secures the float valve and eliminates the need for drilling.

Having described the do-it-yourself methods that are most commonly used in this industry, the present invention addresses the above-referenced faults and will make the aquatic biosphere easier and safer to maintain. Further, it is designed to be a turnkey system that allows every keeper of aquatic species access to state of the art missing water replacement.

### SUMMARY OF THE INVENTION

Having previously discussed existing methodologies for addressing real time replacement of missing water, be it evaporated or otherwise missing, the present invention is far superior and accurate. As evaporation occurs, the float valve drops as the water escapes the tank/container, and releases small amounts of water to replace the water as it vacates the tank. This is superior because the salinity, pH, temperature and myriad of additional water parameters are held at constant levels, set and monitored by the keeper of the species.

Mechanical devices do fail on occasion. The failure of a float valve is most always in an open or partially open position, allowing excessive amounts of replacement water to flood the tank. With the rapid addition of excessive amounts of replacement water, water parameters are quickly changed to the detriment of the species maintained therein. The failure of the float valve can also allow the tank or sump to overflow, spilling water on the floor and damaging flooring and fixtures. The normally closed solenoid greatly reduces the likelihood of such events by closing an internal plunger that shuts off the water supply line and prevents the entry of additional replacement water. The solenoid is controlled by the float switch that is mounted just above the float valve. This redundancy and the additional safety feature that the present invention provides, with the elimination of magnetic drive motors on relays, make the invention substantially different from any existing or prior art. Additionally, further redundancy is added by plugging the power source that energizes and actuates the solenoid into an electronic, programmable timer that only allows the solenoid to open at predetermined times and for designated spans of time.

Further, the ability to adjust the water level to a height required by the keeper, as well as on almost any thickness of wall used in aquarium construction, truly makes the present invention universal in scope and design. Additionally, many keepers of aquatic species live in urban and metropolitan population centers and do not have access or the knowledge to operate a machine shop to build the present invention. This “plug and play” design enables those without any mechanical aptitude to enjoy the protection necessary and provided by the present invention. The body is made of waterproof plastic compounds that are sealed and non-toxic; thereby, greatly reducing the risk that water will enter the body where the electrical wires are located. For further safety reasons, all electrical components are located above the highest possible water level that could ever be achieved to serve as a guard against electrocution or shock. This device successfully eliminates the likelihood of the water holding vessel overflowing and the salinity level from being altered in any appreciable fashion. By eliminating the possibility of overflow, hypo/hyper salinity and eliminating the need of additional reservoirs and pumps, which are not designed to be turned off and on, this design is a tremendous improvements over all prior art and is a substantial improvement in maintaining a stable aquatic environment.

### BRIEF DESCRIPTION OF THE DRAWINGS

Drawing sheet one is a representation of what the apparatus described herein may look like as it is described. Components are non-specific and the bracket will accommodate any number of configurations of different float valves, float switches, solenoids, power converters and electric timers as defined in the claims.

Drawing sheet number two is a flow diagram to demonstrate how the water flows through the apparatus and the points where it many be stopped. Also represented is the flow of electrical current through the apparatus while operating the solenoid.

### DETAILED DESCRIPTION OF THE PREFERRED EMBODIMENTS

A fluid handling apparatus designed for freshwater and saltwater aquaria, which may be configured to maintain the water level in a sump or tank. The apparatus contains a float valve having the ability to release new water into said sump or tank at volumes required to compensate for water evaporation or any other occurring loss of water volume, in real time. Directly above aforementioned float valve, a float switch is positioned to close a solenoid and stop the addition of replacement water in event of the float valve's failure. Said solenoid may be located on top of the hanging bracket, or on the outside tang, and shall be a “normally closed” solenoid. Additionally, the power supply that actuates the solenoid may be plugged into an electronic, programmable timer to further reduce the risk of overflow by limiting operation times that the solenoid is allowed to be opened. The body of this apparatus is made of sealed, watertight materials and is adjustable to set the water level at any height desired. Non-corrosive screws shall be threaded through the outside tang of the bracket to secure the apparatus to accommodate any sized tank wall without allowing any lateral movement. The replacement of water into the tank will maintain a constant water level, further making salinity, pH, temperature, and myriad of water parameters level to preserve the life forms contained therein. The source of said replacement water may be a reverse osmosis/deionization (RO/DI) device, gravity fed hanging reservoir, or a tapped water plumbing pipe or line. The floating actuation devices may be located within the sump or tank, or located externally in a siphon fed box to maintain the levels and maximize available open water space within the aquaria.

That claimed is:

1. An apparatus for replacing evaporated water comprising:
replacement water supplying means for supplying replacement water to an existing body of water;
inert fabricated body applying means positioned downstream from said replacement water supply means providing platforms for mounting a switch, valve and solenoid, and thereby controlling the flow of said replacement water;
solenoid means positioned on top of said inert fabricated body and downstream from said replacement water supply, whereby a normally closed configuration remains open only when energized from an electrical source, and having fluid connectivity from said replacement water supply via connective water tubing;
float switch means positioned beneath the bottom platform of said inert fabricated body having electrical connectivity with either leg of an electrical circuit means having the ability to open the circuit thereby, allowing the solenoid to close, and is actuated by the water level in said existing body of water;
float valve means positioned downstream from said solenoid, being hung from the bottom platform of said inert fabricated body, and in fluid connectivity with said solenoid via connective water tubing means having the ability to meter in water from said replacement water supply into said existing body of water as the level of said existing body of water falls, and closing when said level returns to its original state.
electric timer means positioned downstream of the said solenoid electrical source and plugged directly into said power source.

2. An apparatus as defined in claim 1, wherein upon actuation means by a change in the fluid level of said existing body of water, water from said replacement water supply is allowed to move through said connective water tubing through said solenoid, provided that said solenoid is being held open by said closed circuit sustained by a downward position of said float switch and proper electrical supply, moving to said float valve through said connective water tubing, where said water is allowed to flow into said existing body of water, which is controlled by the position of a float actuated valve releasing said replacement water from a downward position and denying entrance by a level or upward position.

3. An apparatus as defined in claim 2, wherein said inert fabricated body is comprised of a telescoping channel, wherein the electrical wires are sealed, protecting the electrical current from exposure to said replacement water or said existing body of water, while allowing said telescoping channel to be adjusted to set the height of the fluid level of said existing body of water, while also comprising a hanging bracket utilizing inert screws and a suction cup to provide a stable fulcrum point from which said float valve and said float switch to securely apply said replacement water through said float valve, also in fluid connectivity to said float switch in said existing body of water.

4. An apparatus as defined in claim(s) 2 and 3, comprising of an inverted J shaped hanging bracket accommodating a wide variety of wall thicknesses and top aquarium moldings, thereby making said apparatus universal in accommodating most all physical aquarium configurations.

5. An apparatus as defined in claim(s) 2 and 3, comprising of a slip through sleeve having a slightly larger opening than the tubular shaped protective body, containing said electrical wiring, while said sleeve is drilled, threaded and a inert threaded screw secures said protective body to adjust up and down.

6. An apparatus as defined in claim(s) 2 and 3, comprising of plugging in said power supply into a programmable electric timer allowing said solenoid to allow the flow of water from said water supply into said existing body of water at prescribed time(s), and for prescribed intervals of time.
